(19) United States
(12) Patent Application Publication
(10) Pub. No.: US 2024/0062726 A1
(43) Pub. Date: Feb. 22, 2024

(54) DISPLAY DEVICE, METHOD OF DRIVING THE SAME AND DISPLAY PANEL DRIVER

(71) Applicant: Samsung Display Co., Ltd., Yongin-Si (KR)

(72) Inventors: KIHYUN PYUN, Yongin-si (KR); MYOUNGSEOP SONG, Yongin-si (KR)

(21) Appl. No.: 18/141,839

(22) Filed: May 1, 2023

(30) Foreign Application Priority Data
Aug. 18, 2022 (KR) 10-2022-0103629

(51) Int. Cl. G09G 3/3291; G09G 3/3266

(52) U.S. Cl. CPC G09G 3/3291; G09G 3/3266; G09G 2310/0278; G09G 2300/0852; G09G 2320/0271; G09G 2320/0233

(57) ABSTRACT

A display device includes a display panel, a driving controller, a gate driver and a data driver. The display panel includes pixels. The driving controller determines a kickback compensation value of a gate signal according to at least one of a grayscale value of an input image data and a distance from a scan start point of the gate signal. The gate driver is configured to generate the gate signal based on the kickback compensation value and to output the gate signal to the display panel. The data driver is configured to output a data voltage to the display panel.

This application claims priority to Korean Patent Application No. 10-2022-0103629, filed on Aug. 18, 2022, and all the benefits accruing therefrom under 35 U.S.C. § 119, the content of which in its entirety is herein incorporated by reference.

### BACKGROUND

### 1. Field

Embodiments of the inventive concept relate to a display device, a method of driving the same and a display panel driver. More particularly, embodiments of the inventive concept relate to a display device, a method of driving the same and a display panel driver compensating for a luminance change due to a kickback of a gate signal of a transistor.

### 2. Description of the Related Art

The display device includes a display panel and a display panel driver. The display panel may include gate lines, data lines, and pixels. The display panel driver may include a gate driver providing gate signals to the gate lines, a data driver providing data voltages to the data lines, and a driving controller controlling driving timing of the gate driver and the data driver.

When the waveform of the gate signal rapidly decreases from a high level to a low level, a current may be leaked in a transistor due to a kickback, and accordingly, a luminance reduction rate of the pixel may increase. The luminance reduction rate due to the kickback may vary according to a grayscale value of an input image data.

A waveform of the gate signal may vary according to a distance from a scan start point of the gate signal due to a delay in the gate driver. Due to the varied waveform of the gate signal, a degree of the kickback may vary according to a position, and accordingly, a luminance uniformity of the display panel may be deteriorated.

According to the grayscale value of the input image data or the distance from the scan start point of the gate signal, a discoloration may occur or a uniformity of the luminance of the display panel may be reduced.

### SUMMARY

Embodiments of the inventive concept provide a display device compensating for a luminance change due to a kickback of a gate signal of a transistor in a pixel circuit.

Embodiments of the inventive concept provide a method of driving a display device compensating for a luminance change due to a kickback of a gate signal of a transistor in a pixel circuit.

Embodiments of the inventive concept provide a display panel driver compensating for a luminance change due to a kickback of a gate signal of a transistor in a pixel circuit.

In an embodiment of a display device according to the inventive concept, the display device includes a display panel, a driving controller, a gate driver and a data driver. The display panel includes pixels. The driving controller determines a kickback compensation value of a gate signal according to at least one of a grayscale value of an input image data and a distance from a scan start point of the gate signal. The gate driver is configured to generate the gate signal based on the kickback compensation value and to output the gate signal to the display panel. The data driver is configured to output a data voltage to the display panel.

In an embodiment, the driving controller may be configured to determine the kickback compensation value of the gate signal according to both of the grayscale value of the input image data and the distance from the scan start point of the gate signal.

In an embodiment, the kickback compensation value of the gate signal may increase as the grayscale value of the input image data decreases.

In an embodiment, a kickback voltage compensation value of the gate signal may increase as the grayscale value of the input image data decreases.

In an embodiment, a kickback width compensation value of the gate signal may increase as the grayscale value of the input image data decreases.

In an embodiment, the driving controller may be configured to output a gate-on signal determining an on-time of the gate signal and a gate-kickback-on signal determining an on-time of a kickback compensation of the gate signal, and the gate driver may be configured to generate the gate signal based on the gate-on signal and the a gate-kickback-on signal.

In an embodiment, the kickback width compensation value may be determined by an active period of the gate-kickback-on signal.

In an embodiment, a kickback voltage compensation value of the gate signal may increase and a kickback width compensation value of the gate signal may increase, as the grayscale value of the input image data decreases.

In an embodiment, the kickback compensation value of the gate signal may increase as the distance from the scan start point of the gate signal decreases.

In an embodiment, a kickback voltage compensation value of the gate signal may increase as the distance from the scan start point of the gate signal decreases.

In an embodiment, a kickback width compensation value of the gate signal may increase as the distance from the scan start point of the gate signal decreases.

In an embodiment, a kickback voltage compensation value of the gate signal may increase and a kickback width compensation value of the gate signal may increase, as the distance from the scan start point of the gate signal decreases.

In an embodiment, a pixel circuit of the pixels of the display panel may include a first transistor, a second transistor, a third transistor, a first storage capacitor, a second storage capacitor, and a light emitting element. The first transistor includes a gate terminal connected to a first node, a first terminal connected to a second node and a second terminal configured to receive a first power voltage. The second transistor includes a gate terminal configured to receive a first gate signal, a first terminal connected to a date line and a second terminal connected to the first node. The third transistor includes a gate terminal configured to receive a second gate signal, a first terminal connected to a sensing line and a second terminal connected to the second node. The first storage capacitor includes a first terminal connected to the first node and a second terminal connected to the second node. The second storage capacitor includes a first terminal connected to the second node and a second terminal connected to a third node. The light emitting element includes a first terminal connected to the second node and a second terminal configured to receive a second power voltage lower than the first power voltage.

In an embodiment, the driving controller may be configured to determine a kickback compensation value of the first gate signal applied to the gate terminal of the second transistor according to at least one of the grayscale value of the input image data and a distance from a scan start point of the first gate signal.

In an embodiment, the driving controller may be configured to determine a kickback compensation value of the first gate signal applied to the gate terminal of the second transistor and a kickback compensation value of the second gate signal applied to the gate terminal of the third transistor according to at least one of the grayscale value of the input image data and a distance from a scan start point of the first gate signal and the second gate signal.

In an embodiment, the driving controller may include a line memory storing a line data corresponding to one gate line of the display panel, and the driving controller may be configured to determine the kickback compensation value of the gate signal based on the line data.

In an embodiment, the driving controller may be configured to determine the kickback compensation value of the gate signal based on at least one of a maximum grayscale value of the line data, a minimum grayscale value of the line data, and an average grayscale value of the line data.

In an embodiment of a method of driving a display device according to the inventive concept, the method includes determining a kickback compensation value of a gate signal according to at least one of a grayscale value of an input image data and a distance from a scan start point of the gate signal, generating the gate signal based on the kickback compensation value, outputting the gate signal to a display panel, and outputting a data voltage to the display panel.

In an embodiment, the kickback compensation value of the gate signal may increase as the grayscale value of the input image data decreases or as the distance from the scan start point of the gate signal decreases.

In an embodiment of a display panel driver according to the inventive concept, the display panel driver includes a driving controller and a gate driver. The driving controller is configured to determine a kickback compensation value of a gate signal according to at least one of a grayscale value of an input image data and a distance from a scan start point of the gate signal. The gate driver is configured to generate the gate signal based on the kickback compensation value.

According to the display device, the method of driving the same and the display panel driver, a kickback compensation value of the gate signal may be determined according to at least one of the grayscale value of the input image data and the distance from the scan start point of the gate signal, and the gate signal may be generated based on the kickback compensation value.

Thus, a luminance reduction which occurs when an waveform of the gate signal rapidly decreases from a high level to a low level may be controlled according to at least one of the grayscale value of the input image data and the distance from the scan start point of the gate signal.

Consequently, non-uniformity of a luminance and a discoloration of the display panel due to a difference in a degree of a kickback according to the grayscale value of the input image data and the distance from the scan start point of the gate signal may be prevented and a display quality of the display panel may be enhanced.

### BRIEF DESCRIPTION OF THE DRAWINGS

The above and other features of embodiments of the inventive concept will become more apparent by describing in detailed embodiments thereof with reference to the accompanying drawings.

FIG. 1 is a block diagram illustrating a display device according to an embodiment of the inventive concept.

FIG. 2 is a circuit diagram illustrating a pixel of FIG. 1.

FIG. 3 is a block diagram illustrating a driving controller, a gate driver and a power voltage generator of FIG. 1 performing a kickback compensation of a first gate signal of a second transistor of FIG. 2.

FIG. 4 is a graph illustrating a kickback width compensation value of the first gate signal applied to the second transistor of FIG. 2 according to a grayscale value of an input image data.

FIG. 5 is a graph illustrating a kickback voltage compensation value of the first gate signal applied to the second transistor of FIG. 2 according to the grayscale value of the input image data.

FIG. 6 is a graph illustrating the kickback width compensation value of the first gate signal of the second transistor of FIG. 2 according to a distance from a scan start point of the first gate signal.

FIG. 7 is a graph illustrating the kickback voltage compensation value of the first gate signal of the second transistor of FIG. 2 according to the distance from the scan start point of the first gate signal.

FIG. 8 is a timing diagram illustrating an embodiment of a waveform of the first gate signal of the second transistor of FIG. 2 according to a first gate-on signal and a first gate-kickback-on signal.

FIG. 9 is a timing diagram illustrating an embodiment of the waveform of the first gate signal of the second transistor of FIG. 2 according to the first gate-on signal and the first gate-kickback-on signal.

FIG. 10 is a timing diagram illustrating an embodiment of the waveform of the first gate signal of the second transistor of FIG. 2 according to the first gate-on signal and the first gate-kickback-on signal.

FIG. 11 is a block diagram illustrating a driving controller, a gate driver, and a power voltage generator performing the kickback compensation of the first gate signal of the second transistor of FIG. 2 and a kickback compensation of a second gate signal of a third transistor of FIG. 2.

FIG. 12 is a graph illustrating a kickback width compensation value of the second gate signal of the third transistor of FIG. 2 according to the grayscale value of the input image data.

FIG. 13 is a graph illustrating the kickback voltage compensation value of the second gate signal of the third transistor of FIG. 2 according to the grayscale value of the input image data.

FIG. 14 is a graph illustrating the kickback width compensation value of the second gate signal of the third transistor of FIG. 2 according to a distance from a scan start point of the second gate signal.

FIG. 15 is a graph illustrating the kickback voltage compensation value of the second gate signal of the third transistor of FIG. 2 according to the distance from the scan start point of the second gate signal.

FIG. 16 is a timing diagram illustrating an embodiment of a waveform of the second gate signal of the third transistor of FIG. 2 according to a second gate-on signal and a second gate-kickback-on signal.

FIG. 17 is a timing diagram illustrating an embodiment of a waveform of the second gate signal of the third transistor of FIG. 2 according to the second gate-on signal and the second gate-kickback-on signal.

FIG. 18 is a timing diagram illustrating an embodiment of a waveform of the second gate signal of the third transistor of FIG. 2 according to the second gate-on signal and the second gate-kickback-on signal.

FIG. 19 is a flowchart illustrating a method of driving the display device according to an embodiment of the inventive concept.

FIG. 20 is a block diagram illustrating an electronic device according to embodiment of the inventive concept.

FIG. 21 is a diagram illustrating an embodiment in which the electronic device of FIG. is implemented as a smart phone.

### DETAILED DESCRIPTION

Hereinafter, embodiments of the inventive concept will be described in detail with reference to the accompanying drawings.

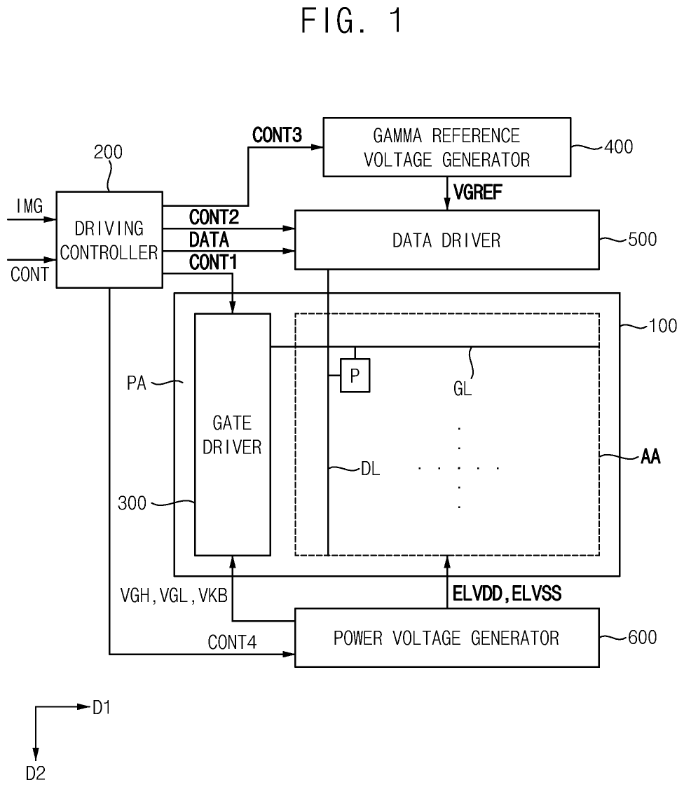

FIG. 1 is a block diagram illustrating a display device according to an embodiment of the inventive concept.

Referring to FIG. 1, the display device includes a display panel 100 and a display panel driver. The display panel driver includes a driving controller 200, a gate driver 300, a gamma reference voltage generator 400, and a data driver 500. The display panel driver may further include a power voltage generator 600.

For example, the driving controller 200 and the data driver 500 may be integrally formed. For example, the driving controller 200, the gamma reference voltage generator 400, and the data driver 500 may be integrally formed. For example, the driving controller 200, the gamma reference voltage generator 400, the data driver 500, and the power voltage generator 600 may be integrally formed. A driving module including at least the driving controller 200 and the data driver 500 which are integrally formed may be referred to as a timing controller embedded data driver (TED).

The display panel 100 includes a display region AA displaying an image and a peripheral region PA disposed adjacent to the display region AA.

For example, in the present embodiment, the display panel 100 may be an organic light emitting diode display panel including organic light emitting diodes. For example, the display panel 100 may be a quantum-dot organic light emitting diode display panel including organic light emitting diodes and quantum-dot color filters. For example, the display panel 100 may be a quantum-dot nano light emitting diode display panel including nano light emitting diodes and quantum-dot color filters.

The display panel 100 includes gate lines GL, data lines DL, and pixels P electrically connected to the gate lines GL and the data lines DL. The gate lines GL may extend in a first direction D1 and the data lines DL may extend in a second direction D2 crossing the first direction D1.

The driving controller 200 may receive input image data IMG and an input control signal CONT from an external device, e.g., a host or an application processor. For example, the input image data IMG may include red image data, green image data, and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of a gamma reference voltage generator 400 based on the input control signal CONT, and outputs the third control signal CONT3 to the gamma reference voltage generator 400.

The driving controller 200 generates the fourth control signal CONT4 for controlling an operation of the power voltage generator 600 based on the input control signal CONT, and outputs the fourth control signal CONT4 to the power voltage generator 600.

The gate driver 300 generates gate signals driving the gate lines GL in response to the first control signal CONT1 received from the driving controller 200. The gate driver 300 outputs gate signals to the gate lines GL. For example, the gate driver 300 may sequentially output the gate signals to the gate lines GL. For example, the gate driver 300 may be integrated on the peripheral region PA of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF is used to convert the data signal DATA into an analog data voltage.

In an embodiment of the inventive concept, the gamma reference voltage generator 400 may be disposed in the driving controller 200 or in the data driver 500.

The data driver 500 receives the second control signal CONT2 and the data signal DATA from the driving controller 200, and receives the gamma reference voltage VGREF from the gamma reference voltage generator 400. The data driver 500 converts the data signal DATA into the analog data voltage using the gamma reference voltage VGREF. The data driver 500 outputs a data voltage to the data line DL.

The power voltage generator 600 may generate a first power voltage ELVDD and output the first power voltage ELVDD to the display panel 100. The power voltage generator 600 may generate a second power voltage ELVSS and output the second power voltage ELVSS to the display panel 100. The first power supply voltage ELVDD may be a high power applied to the pixels P of the display panel 100, and the second power supply voltage ELVSS may be a low power applied to pixels P of the display panel 100.

The power voltage generator 600 may generate a gate driving voltage for driving the gate driver 300 and output the gate driving voltage to the gate driver 300, and may generate a data driving voltage for driving the data driver 500 and output the data driving voltage to the data driver 500. The power voltage generator 600 may generate a gate high voltage VGH indicating a high level of the gate signal and a gate low voltage VGL indicating a low level of the gate signal, and may output the gate high voltage VGH and the gate low voltage VGL to the gate driver 300. The power voltage generator 600 may generate a kickback voltage compensation value VKB for a kickback compensation of the gate signal and output the kickback voltage compensation value VKB to the gate driver 300.

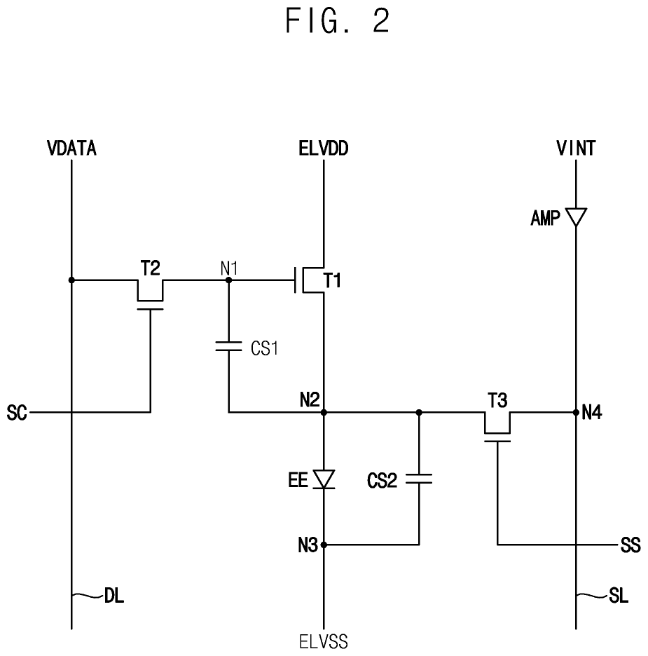

FIG. 2 is a circuit diagram illustrating the pixel P of FIG. 1.

Referring to FIG. 1 and FIG. 2, a pixel circuit of the pixel P of the display panel 100 may include a first transistor T1 including a gate terminal connected to a first node N1, a first terminal connected to a second node N2 and a second terminal receiving a first power voltage ELVDD. A second transistor T2 includes a gate terminal receiving a first gate signal SC, a first terminal connected to the date line DL and a second terminal connected to the first node N1. A third transistor T3 includes a gate terminal receiving a second gate signal SS, a first terminal connected to a sensing line SL and a second terminal connected to the second node N2. The pixel circuit may include a first storage capacitor CS1 including a first terminal connected to the first node N1 and a second terminal connected to the second node N2. A second storage capacitor CS2 includes a first terminal connected to the second node N2 and a second terminal connected to a third node N3. An amplifier AMP includes a first terminal receiving an initialization voltage VINT and a second terminal connected to a fourth node N4. A light emitting element EE including a first terminal connected to the second node N2 and a second terminal receiving a second power voltage ELVSS lower than the first power voltage ELVDD.

The first transistor T1 may flow a driving current corresponding to a voltage of the first node N1 to the light emitting element EE. When the second transistor T2 is turned on in response to the first gate signal SC, the data voltage VDATA may be transmitted to the first node N1 through the second transistor T2. When the third transistor T3 is turned on in response to the second gate signal SS, the initialization voltage VINT may be transferred to the second node N2.

The first storage capacitor CS1 may be charged with a voltage difference between the voltage of the first node N1 and a voltage of the second node N2. The second storage capacitor CS2 may be charged with a voltage difference between the voltage of the second node N2 and a voltage of the third node N3.

For example, the amplifier AMP may be a buffer having a unity gain. The amplifier AMP may transmit the initialization voltage VINT to the fourth node N4.

The light emitting element EE may emit light having a predetermined luminance based on the driving current provided from the first transistor T1. In an embodiment, the light emitting element EE may be an organic light emitting diode including an organic light emitting layer. In an embodiment, the light emitting element EE may be an inorganic light emitting element including an inorganic material.

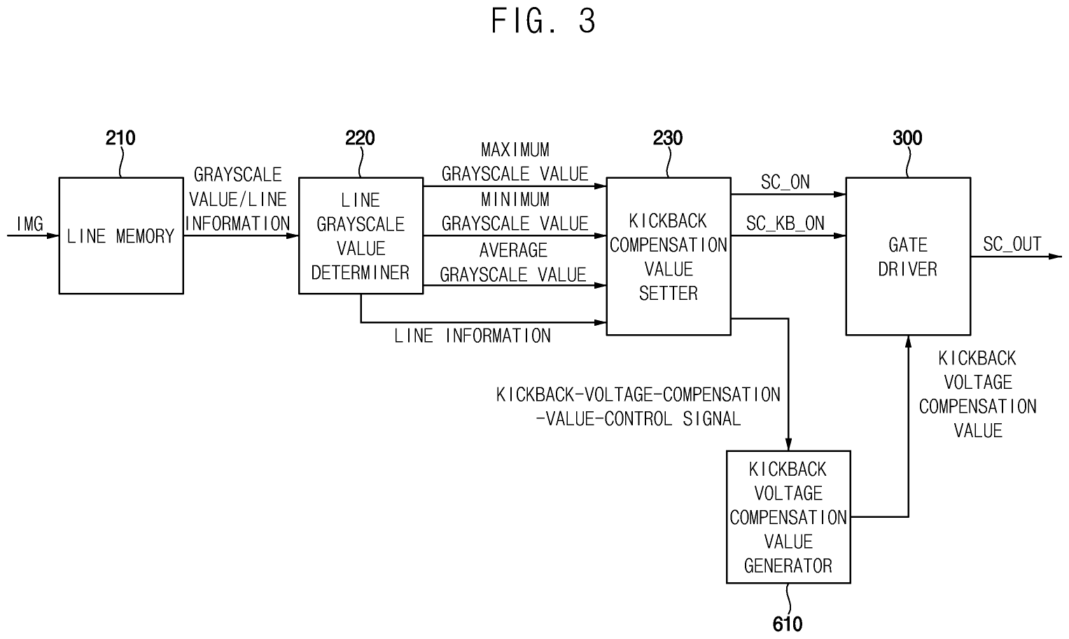

FIG. 3 is a block diagram illustrating the driving controller 200, the gate driver 300 and the power voltage generator 600 of FIG. 1 performing the kickback compensation of the first gate signal SC of the second transistor T2 of FIG. 2.

Referring FIGS. 1 to 3, the driving controller 200, the gate driver 300, and the power voltage generator 600 of FIG. 3 may compensate for a kickback of the first gate signal SC of the second transistor T2 of FIG. 2.

The driving controller 200 may include a line memory 210, a line grayscale value determiner 220, and a kickback compensation value setter 230. The power voltage generator 600 may include a kickback voltage compensation value generator 610. Alternatively, the driving controller 200 may include the kickback voltage compensation value generator 610.

The line memory 210 may store the input image data IMG for one pixel row, e.g., pixel data including the grayscale value of the input image data IMG and a line information, of the display panel 100 line by line. The input image data IMG for the one pixel row may be referred to as a line data.

The line grayscale value determiner 220 may extract at least one of a maximum grayscale value, a minimum grayscale value, and an average grayscale value from the line data. The line grayscale value determiner 220 may provide at least one of the maximum grayscale value, the minimum grayscale value, and the average grayscale value to the kickback compensation value setter 230. In addition, the line grayscale value determiner 220 may provide the line information to the kickback compensation value setter 230.

The kickback compensation value setter 230 may determine a kickback compensation value of the gate signal according to the grayscale value of the input image data IMG or a distance from a scan start point of the gate signal, i.e., according to at least one of the grayscale value of the input image data IMG and the distance from the scan start point of the gate signal. The kickback compensation method may be a kickback width compensation and/or a kickback voltage compensation.

The kickback compensation value setter 230 may provide a first gate-on signal SC_ON and a first gate-kickback-on signal SC_KB_ON to the gate driver 300 according to the kickback compensation value. The kickback compensation value setter 230 may provide a kickback-voltage-compensation-value-control signal to the kickback voltage compensation value generator 610.

In an embodiment, the kickback compensation value setter 230 may vary the kickback compensation value for the first gate signal SC of the second transistor T2 according to the grayscale value of the input image data IMG. Here, the grayscale value of the input image data IMG may be any one of the maximum grayscale value, the minimum grayscale value, and the average grayscale value for each line received by the line grayscale value determiner 220 from the line memory 210.

For example, when the grayscale value of the input image data IMG increases, the data voltage VDATA may increase. For example, when the data voltage VDATA corresponding to the grayscale value of 32Gray is 3V, the data voltage VDATA corresponding to a grayscale value of 255Gray may be 8V. When the data voltage VDATA increases, an amount of electric charge to be charged in the first storage capacitor CS1 may increase according to an equation of Q=CV, where, Q may be the amount of electric charge, C may be a capacitance, and V may be a voltage. That is, when the grayscale value of the input image data IMG increases, the amount of electric charge to be charged may increase. Accordingly, when the grayscale value of the input image data IMG increases, time for charging the first storage capacitor CS1 increases, and when an actual charging time is less than a target time, a charging rate may be less than a target value. When the grayscale value of the input image data IMG increases, the charging rate may be less than the target value.

In addition, the luminance may decrease due to a kickback phenomenon. When the second transistor T2 is turned on in response to the first gate signal SC, the data voltage VDATA applied through the second transistor T2 may be transferred to the first node N1. The second transistor T2 may be turned off in response to the first gate signal SC. For example, when the second transistor T2 is turned off in response to the first gate signal SC, the first gate signal SC of the second transistor T2 may rapidly change from the gate high voltage VGH to the gate low voltage VGL. When the first gate signal SC of the second transistor T2 rapidly decreases, the kickback phenomenon in which current leaks from the transistor may occur. The data voltage VDATA transmitted to the first node N1 through the second transistor T2 may be lower than the original data voltage VDATA and the data voltage VDATA lower than the original data voltage VDATA may be applied to the gate terminal of the first transistor T1.

When the third transistor T3 is turned on in response to the second gate signal SS, the initialization voltage VINT may be transferred to the second node N2. The third transistor T3 may be turned off in response to the second gate signal SS. For example, the second gate signal SS of the third transistor T3 may rapidly change from the gate high voltage VGH to the gate low voltage VGL. When the second gate signal SS of the third transistor T3 rapidly decreases, the kickback phenomenon in which current leaks from the transistor may occur. In this case, the initialization voltage VINT applied to the second node N2 through the third transistor T3 may be higher than the original initialization voltage VINT and the initialization voltage VINT higher than the original initialization voltage VINT may be applied to the second node N2.

As such, due to the kickback phenomenon, a voltage applied to the gate terminal of the first transistor T1 may decrease, and a voltage applied to the first terminal of the first transistor T1 may increase.

In this case, a reduced magnitude of the voltage applied to the gate terminal of the first transistor T1 due to the kickback phenomenon may be substantially constant regardless of the grayscale value. In addition, an increased magnitude of the voltage applied to the first terminal of the first transistor T1 due to the kickback phenomenon may be substantially constant regardless of the grayscale value.

The data voltage VDATA may increase as the grayscale value of the input image data IMG increases. Even if the data voltage VDATA transmitted to the first transistor T1 decreases by a constant value due to the kickback phenomenon, a reduction rate of the data voltage VDATA may be higher in a low grayscale value than in a high grayscale value. Accordingly, the luminance reduction rate due to the kickback phenomenon may increase as the grayscale value of the input image data IMG decreases. For example, the data voltage VDATA may be 3V for the grayscale value of 32Gray, and the data voltage VDATA may be 8V for the grayscale value of 255Gray. When it is assumed that 0.4V is decreased due to the kickback phenomenon, the voltage applied to the gate terminal of the first transistor T1 is reduced from 3V to 2.6V due to the kickback phenomenon for the grayscale value of 32Gray, and the voltage applied to the gate terminal of the first transistor T1 is reduced from 8V to 7.6V due to the kickback phenomenon for the grayscale value of 255Gray Therefore, as the grayscale value of the input image data IMG decreases, the luminance reduction rate due to the kickback phenomenon may increase.

When a slew rate characteristic of the gate signal is high, an amount of leakage current due to a rapid change of the gate signal may be high. Therefore, as the slew rate characteristic of the gate signal is high, the luminance reduction rate may be high. As the distance from the scan start point of the gate signal increases, the slew rate characteristic may deteriorate due to a signal propagation delay in the gate driver 300. That is, as the distance from the scan start point of the gate signal increases, a luminance reduction due to the kickback phenomenon may decrease. Accordingly, a luminance may not be uniform according to the distance from the scan start point of the gate signal. The luminance of the display panel 100 is non-uniform, so that a discoloration may occur.

Accordingly, the kickback compensation may be performed to prevent the luminance non-uniformity of the display panel 100 according to the grayscale value of the input image data IMG and the distance from the scan start point of the gate signal due to the kickback phenomenon.

For example, the kickback compensation method may include the kickback width compensation and the kickback voltage compensation.

The kickback width compensation may mean adjusting a degree of a slice of the waveform of the gate signal by adjusting the kickback compensation activation period when the gate signal is changed from the gate high voltage VGH to the gate low voltage VGL.

The kickback voltage compensation may mean adjusting the degree of the slice of the waveform of the gate signal by adjusting the kickback voltage compensation value when the gate signal is changed from the gate high voltage VGH to the gate low voltage VGL.

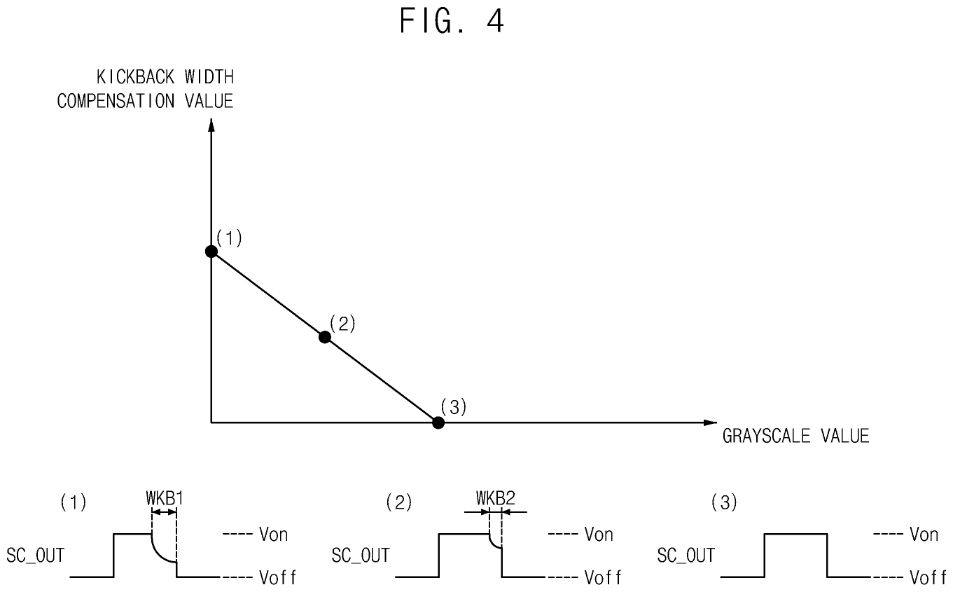

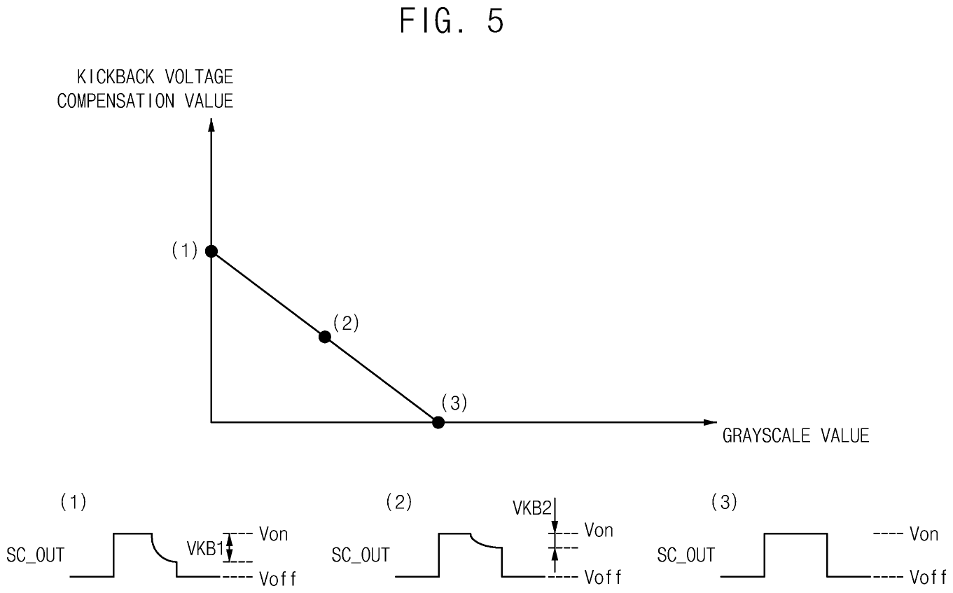

FIG. 4 is a graph illustrating the kickback width compensation value of the first gate signal SC applied to the second transistor T2 of FIG. 2 according to the grayscale value of the input image data IMG. FIG. 5 is a graph illustrating the kickback voltage compensation value of the first gate signal SC applied to the second transistor T2 of FIG. 2 according to the grayscale value of the input image data IMG.

Referring to FIG. 4, the kickback width compensation value may be varied according to the grayscale value of the input image data IMG. As the grayscale value of the input image data IMG decreases, the luminance reduction rate due to the kickback phenomenon may increase. Accordingly, the kickback compensation value of the gate signal, e.g., SC_OUT, may be increased as the grayscale value of the input image data IMG is decreased.

As the kickback width compensation value increases, a slice period of the waveform of the gate signal, e.g., SC_OUT, may increase and the kickback compensation value may increase. That is, as the grayscale value of the input image data IMG decreases, the kickback width compensation value of the gate signal, e.g., SC_OUT, may be set to increase.

In FIG. 4, Case (1) may represent a case in which the grayscale value is the smallest, and the kickback width compensation value WKB1 of the gate signal, e.g., SC_OUT, in Case (1) may be the largest. Case (2) may represent a case in which a grayscale value of Case (2) is larger than a grayscale value of Case (1), and the kickback width compensation value WKB2 of the gate signal, e.g., SC_OUT, in Case (2) may be smaller than the kickback width compensation value WKB1 in Case (1). Case (3) may represent a case in which the grayscale value is the largest, and the kickback width compensation value of the gate signal, e.g., SC_OUT, in Case (3) may be the smallest. For example, in Case (3) of FIG. 4, the kickback width compensation value may be 0.

Referring to FIG. 5, the kickback voltage compensation value may be varied according to the grayscale value of the input image data IMG. As the grayscale value of the input image data IMG decreases, the luminance reduction rate due to the kickback phenomenon may increase. Accordingly, the kickback compensation value of the gate signal, e.g., SC_OUT, may increase as the grayscale value of the input image data IMG decreases.

As the kickback voltage compensation value increases, the waveform of the gate signal, e.g., SC_OUT, may be sliced to a lower voltage and the kickback compensation value may be larger. That is, as the grayscale value of the input image data IMG decreases, the kickback voltage compensation value of the gate signal, e.g., SC_OUT, may be set to increase.

In FIG. 5, Case (1) may represent a case in which the grayscale value is the smallest, and the kickback voltage compensation value VKB1 of the gate signal, e.g., SC_OUT, in Case (1) may be the largest. Case (2) may represent a case in which a grayscale value of Case (2) is larger than a grayscale value of Case (1), and the kickback voltage compensation value VKB2 of the gate signal, e.g., SC_OUT, in Case (2) may be smaller than the kickback voltage compensation value VKB1 in Case (1). Case (3) may represent a case in which the grayscale value is the largest, and the kickback voltage compensation value of the gate signal, e.g., SC_OUT, in Case (3) may be the smallest. For example, in Case (3) of FIG. 5, the kickback voltage compensation value may be VGH, e.g., Von. As such, as the grayscale value increases, the kickback voltage compensation value of the gate signal, e.g., SC_OUT, may decrease.

FIG. 4 illustrates the case in which the kickback width compensation value of the gate signal, e.g., SC_OUT, increases as the grayscale value decreases, and FIG. 5 illustrates the case in which the kickback voltage compensation value of the gate signal, e.g., SC_OUT, increases as the grayscale value decreases, but both the kickback width compensation illustrated in FIG. 4 and the kickback voltage compensation illustrated in FIG. 5 may be applied. Accordingly, as the grayscale value decreases, the kickback voltage compensation value of the gate signal, e.g., SC_OUT, may increase, and the kickback width compensation value of the gate signal, e.g., SC_OUT, may increase.

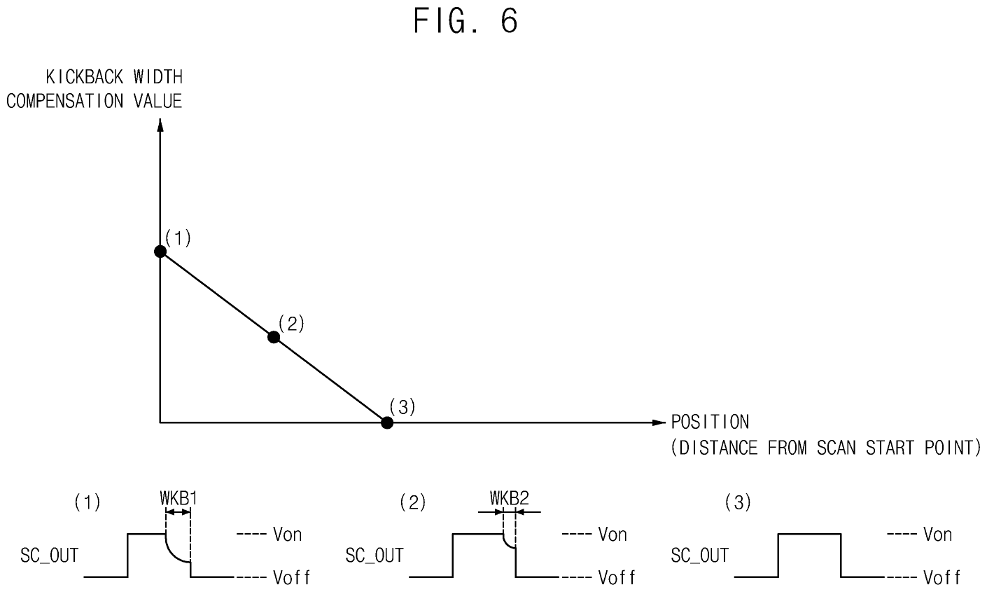

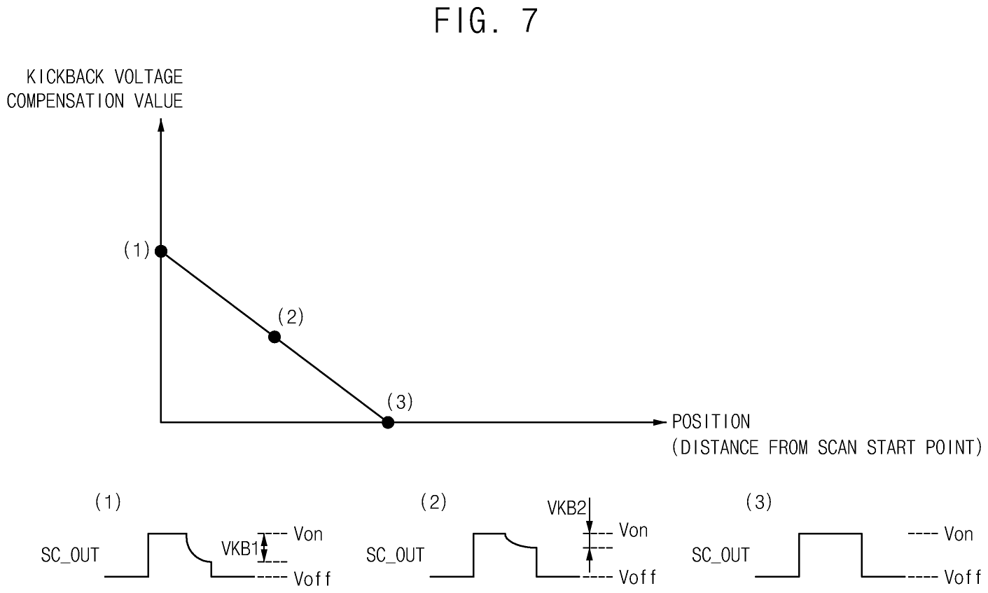

FIG. 6 is a graph illustrating the kickback width compensation value of the first gate signal SC of the second transistor T2 of FIG. 2 according to the distance from the scan start point of the first gate signal SC. FIG. 7 is a graph illustrating the kickback voltage compensation value of the first gate signal SC of the second transistor T2 of FIG. 2 according to the distance from the scan start point of the first gate signal SC.

Referring to FIG. 6, the kickback width compensation value may be varied according to the distance from the scan start point of the gate signal, e.g., SC_OUT. When the distance from the scan start point of the gate signal, e.g., SC_OUT, is short, the slew rate characteristic of the gate signal, e.g., SC_OUT, may be high. In addition, an effect due to the kickback phenomenon may increase. Accordingly, the kickback compensation value of the gate signal, e.g., SC_OUT, may increase as the distance from the scan start point of the gate signal, e.g., SC_OUT, is short.

As the kickback width compensation value increases, the slice period of the waveform of the gate signal, e.g., SC_OUT, may increase and the kickback compensation value may increase. That is, as the distance from the scan start point of the gate signal, e.g., SC_OUT, is short, the kickback width compensation value of the gate signal, e.g., SC_OUT, may be set to increase.

In FIG. 6, Case (1) may represent a case in which the distance from the scan start point is the shortest, and the kickback width compensation value WKB1 of the gate signal, e.g., SC_OUT, in Case (1) may be the largest. Case (2) may represent a case in which a distance from the scan start point of Case (2) is longer than a distance from the scan start point of Case (1), and the kickback width compensation value WKB2 of the gate signal, e.g., SC_OUT, in Case (2) may be smaller than the kickback width compensation value WKB1 in Case (1). Case (3) may represent a case in which the distance from the scan start point is the longest, and the kickback width compensation value of the gate signal, e.g., SC_OUT, in Case (3) may be the smallest. In Case (3) of FIG. 6, the case in which the kickback width compensation value may be 0.

Referring to FIG. 7, the kickback voltage compensation value may be varied according to the distance from the scan start point of the gate signal, e.g., SC_OUT. When the distance from the scan start point of the gate signal, e.g., SC_OUT, is short, the slew rate characteristic of the gate signal, e.g., SC_OUT, may be high. In addition, the effect due to the kickback phenomenon may increase. Accordingly, the kickback compensation value of the gate signal, e.g., SC_OUT, may increase as the distance from the scan start point of the gate signal, e.g., SC_OUT, is shorter.

As the kickback voltage compensation value increases, the waveform of the gate signal, e.g., SC_OUT, may be sliced to a lower voltage and the kickback compensation value may be larger. That is, as the distance from the scan start point of the gate signal, e.g., SC_OUT, is short, the kickback voltage compensation value of the gate signal, e.g., SC_OUT, may be set to increase.

In FIG. 7, Case (1) may represent a case in which the distance from the scan start point is the shortest, and the kickback voltage compensation value VKB1 of the gate signal, e.g., SC_OUT, in Case (1) may be the largest. Case (2) may represent a case in which a distance from a scan start point of Case (2) is longer than the distance from the scan start point of Case (1), and the kickback voltage compensation value VKB2 of the gate signal, e.g., SC_OUT, in Case (2) may be smaller than the kickback voltage compensation value VKB1 in Case (1). Case (3) may represent a case in which the distance from the scan start point is the longest, and the kickback voltage compensation value of the gate signal, e.g., SC_OUT, in Case (3) may be the smallest. In Case (3) of FIG. 7, the kickback voltage compensation value may be VGH, e.g., Von.

FIG. 6 represents the case in which the kickback width compensation value of the gate signal, e.g., SC_OUT, increases as the distance from the scan start point decreases, and FIG. 7 represents the case in which the kickback voltage compensation value of the gate signal, e.g., SC_OUT, increases as the distance from the scan start point decreases, but both the kickback width compensation illustrated in FIG. 6 and the kickback voltage compensation illustrated in FIG. 7 may be applied. Accordingly, as the distance from the scan start point decreases, the kickback voltage compensation value of the gate signal, e.g., SC_OUT, may increase, and the kickback width compensation value of the gate signal, e.g., SC_OUT, may increase.

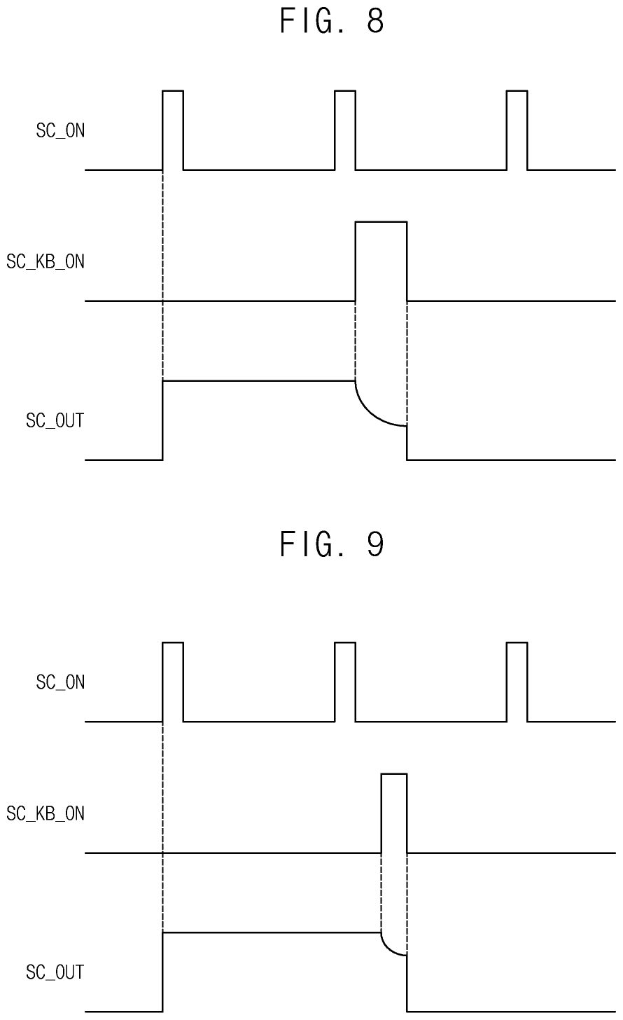

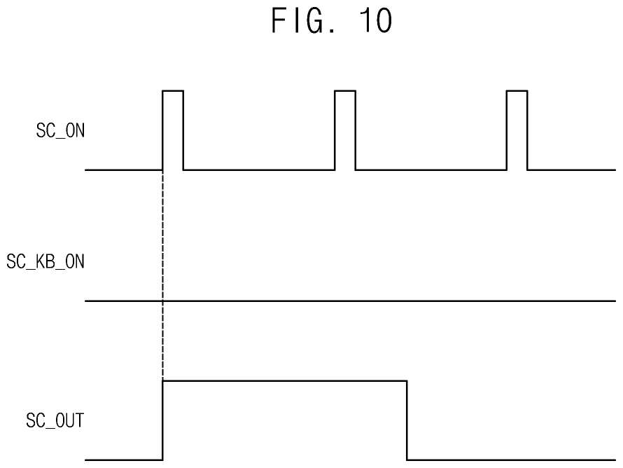

FIG. 8 is a timing diagram illustrating an embodiment of a waveform of the first gate signal SC of the second transistor T2 of FIG. 2 according to a first gate-on signal SC_ON and a first gate-kickback-on signal SC_KB_ON. FIG. 9 is a timing diagram illustrating an embodiment of the waveform of the first gate signal SC of the second transistor T2 of FIG. 2 according to the first gate-on signal SC_ON and the first gate-kickback-on signal SC_KB_ON. FIG. 10 is a timing diagram illustrating an embodiment of the waveform of the first gate signal SC of the second transistor T2 of FIG. 2 according to the first gate-on signal SC_ON and the first gate-kickback-on signal SC_KB_ON.

Referring FIGS. 8 to 10, the driving controller 200 may output the first gate-on signal SC_ON determining an on-time of the first gate signal SC_OUT sequentially applied to pixel rows and the first gate-kickback-on signal SC_KB_ON determining an on-time of the kickback compensation of the first gate signal SC_OUT sequentially applied to the pixel rows to the gate driver 300.

The gate driver 300 may generate the kickback-compensated first gate signal SC_OUT based on the first gate-on signal SC_ON and the first gate-kickback-on signal SC_KB_ON.

For example, the kickback width compensation value of the first gate signal SC_OUT may be determined by an active period of the first gate-kickback-on signal SC_KB_ON. The on-time of the first gate signal SC_OUT may be a time point at which an active period of the first gate-on signal SC_ON starts. An off-time of the first gate signal SC_OUT may be a time point at which an active period of the first gate-kickback-on signal SC_KB_ON ends.

The first gate-on signal SC_ON may have pulses. When the first gate-on signal SC_ON is periodically activated, the activated first gate signal SC_OUT may be sequentially applied to the pixel rows.

FIG. 8 represents a case in which the kickback width compensation value is the largest. In FIG. 8, the waveform of the first gate signal SC_OUT may be sliced by the active period of the first gate-kickback-on signal SC_KB_ON. Since the active period of the first gate-kickback-on signal SC_KB_ON of FIG. 8 is the longest, the kickback width compensation value of the first gate signal SC_OUT may be the largest.

FIG. 9 represents a case in which the kickback width compensation value of FIG. 9 is smaller than the kickback width compensation value of FIG. 8. In FIG. 9, the waveform of the first gate signal SC_OUT may be sliced by the active period of the first gate-kickback-on signal SC_KB_ON. Since the active period of the first gate-kickback-on signal SC_KB_ON of FIG. 9 is shorter than the active period of the first gate-kickback-on signal SC_KB_ON of FIG. 8, the kickback width compensation value of the first gate signal SC_OUT of FIG. 9 may be smaller than the kickback width compensation value of the first gate signal SC_OUT of FIG. 8.

FIG. 10 represents a case in which the kickback width compensation value is the smallest. In FIG. 10, since there is no active period of the first gate-kickback-on signal SC_KB_ON, the waveform of the first gate signal SC_OUT may not be sliced.

In the present embodiment, the kickback compensation value of the gate signal SC may be determined according to at least one of the grayscale value of the input image data IMG and the distance from the scan start point of the gate signal SC, and the gate signal SC may be generated based on the kickback compensation value.

A luminance reduction, which occurs when the waveform of the gate signal SC rapidly decreases from the high level to the low level, may be determined by the grayscale value of the input image data IMG or the distance from the scan start point of the gate signal SC.

Consequently, non-uniformity of the luminance and a discoloration of the display panel 100 due to the difference in the degree of the kickback according to the grayscale value of the input image data IMG and the distance from the scan start point of the gate signal SC may be prevented and the display quality of the display panel 100 may be enhanced.

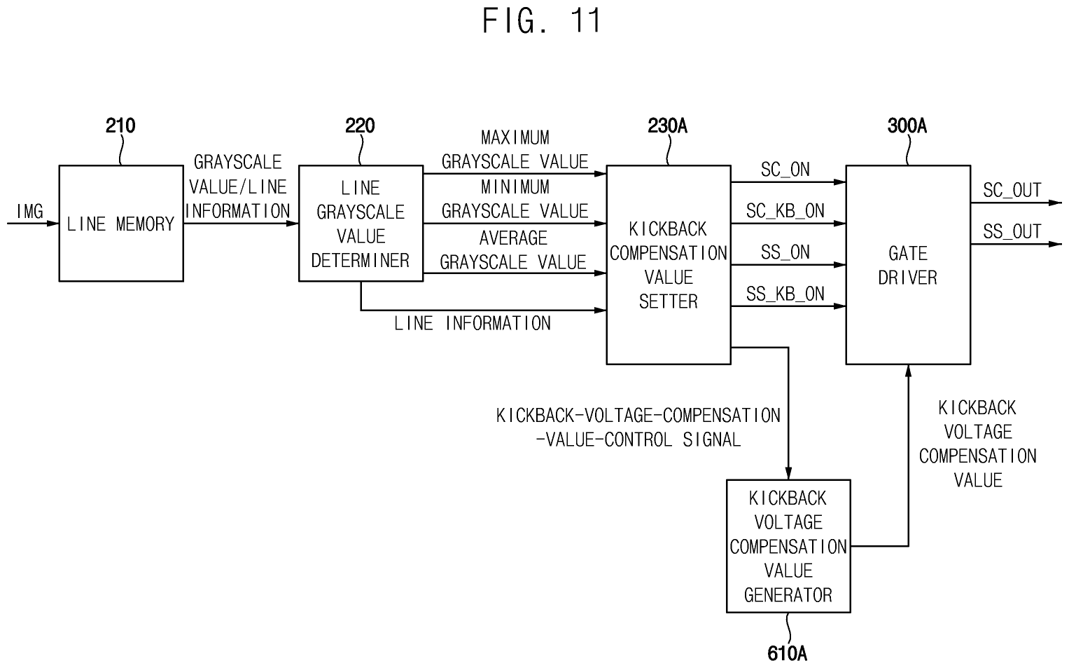

FIG. 11 is a block diagram illustrating the driving controller 200, the gate driver 300, and the power voltage generator 600 performing the kickback compensation of the first gate signal SC of the second transistor T2 of FIG. 2 and the kickback compensation of the second gate signal SS of the third transistor T3 of FIG. 2.

A display device, a method for driving the same and the display panel driver of FIG. 11 and the display device, the method for driving the same and the display panel driver of FIG. 3 is substantially the same except for further performing a kickback compensation of the second gate signal SS of the third transistor T3. Therefore, identical reference numbers are used for identical or similar components, and overlapping descriptions are omitted.

Referring to FIGS. 1 to 11, the driving controller 200, a gate driver 300A, and the power voltage generator 600 may compensate for the kickback of the first gate signal SC of the second transistor T2 of FIG. 2 and the kickback of the second gate signal SS of the third transistor T3 of FIG. 2.

The driving controller 200 may include the line memory 210, the line grayscale value determiner 220, and a kickback compensation value setter 230A. The power voltage generator 600 may include a kickback voltage compensation value generator 610A. Alternatively, the driving controller 200 may include the kickback voltage compensation value generator 610A.

The kickback compensation value setter 230A may determine the kickback compensation value of the gate signals SC, SS according to at least one of the grayscale value of the input image data IMG and the distance from the scan start point of the gate signals SC, SS. The kickback compensation may be the kickback width compensation and/or a kickback voltage compensation.

The kickback compensation value setter 230A may provide the first gate-on signal SC_ON, the first gate-kickback-on signal SC_KB_ON, a second gate-on signal SS_ON, and a second gate-kickback-on signal SS_KB_ON to the gate driver 300A. The kickback compensation value setter 230A may provide a kickback-voltage-compensation-value-control signal to the kickback voltage compensation value generator 610A. In the present embodiment, the kickback-voltage-compensation-value-control signal may include a first kickback-voltage-compensation-value-control signal for determining a level of the kickback voltage compensation value of the first gate signal SC and a second kickback-voltage-compensation-value-control signal for determining a level of the kickback voltage compensation value of the second gate signal SS.

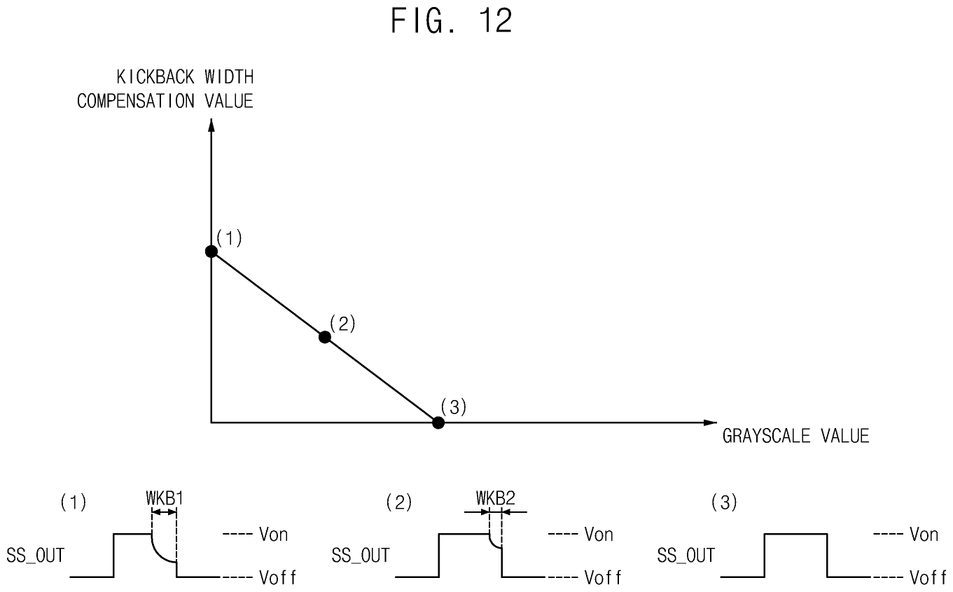

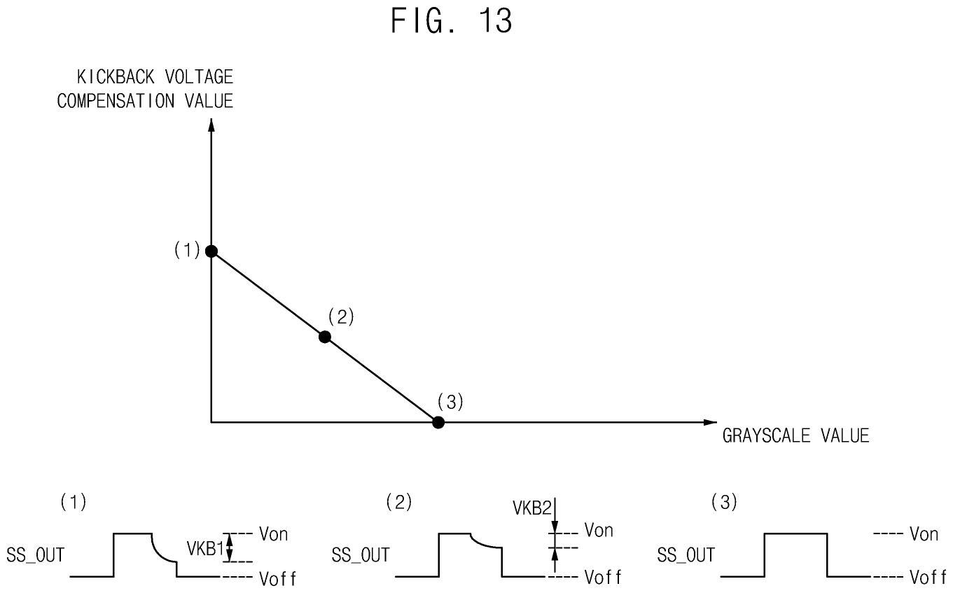

FIG. 12 is a graph illustrating the kickback width compensation value of the second gate signal SS of the third transistor T3 of FIG. 2 according to the grayscale value of the input image data IMG. FIG. 13 is a graph illustrating the kickback voltage compensation value of the second gate signal SS of the third transistor T3 of FIG. 2 according to the grayscale value of the input image data IMG.

As described with reference to FIGS. 4 and 5, the kickback width compensation value of the first gate signal SC_OUT may be set to increase as the grayscale value of the input image data IMG decreases, and the kickback voltage compensation value of the first gate signal SC_OUT may be set to increase.

Referring to FIG. 12, the kickback width compensation value of the second gate signal SS_OUT may increase as the grayscale value of the input image data IMG is smaller. The kickback width compensation value of the second gate signal SS_OUT may be set to increase as the grayscale value of the input image data IMG is smaller.

In FIG. 12, Case (1) may represent a case in which the grayscale value is the smallest, and the kickback width compensation value WKB1 of the second gate signal SS_OUT in Case (1) may be the largest. Case (2) may represent a case in which a grayscale value of Case (2) is larger than the grayscale value of case (1), and the kickback width compensation value WKB2 of the second gate signal SS_OUT in Case (2) may be smaller than the kickback width compensation value WKB1 in Case (1). Case (3) may represent a case in which the grayscale value is the largest, and the kickback width compensation value of the second gate signal SS_OUT in Case (3) may be the smallest.

Referring to FIG. 13, the kickback voltage compensation value of the second gate signal SS_OUT may increase as the grayscale value of the input image data IMG decreases, and as the grayscale value of the input image data IMG decreases, the kickback voltage compensation value of the second gate signal SS_OUT may be set to increase.

In FIG. 13, Case (1) may represent a case in which the grayscale value is the smallest, and the kickback voltage compensation value VKB1 of the second gate signal SS_OUT in Case (1) may be the largest. Case (2) may represent a case in which a grayscale value of Case (2) is larger than a grayscale value of Case (1), and the kickback voltage compensation value VKB2 of the second gate signal SS_OUT in Case (2) may be smaller than the kickback width compensation value VKB1 in Case (1). Case (3) may represent a case in which the grayscale value is the largest, and the kickback voltage compensation value of the second gate signal SS_OUT in Case (3) may be the smallest.

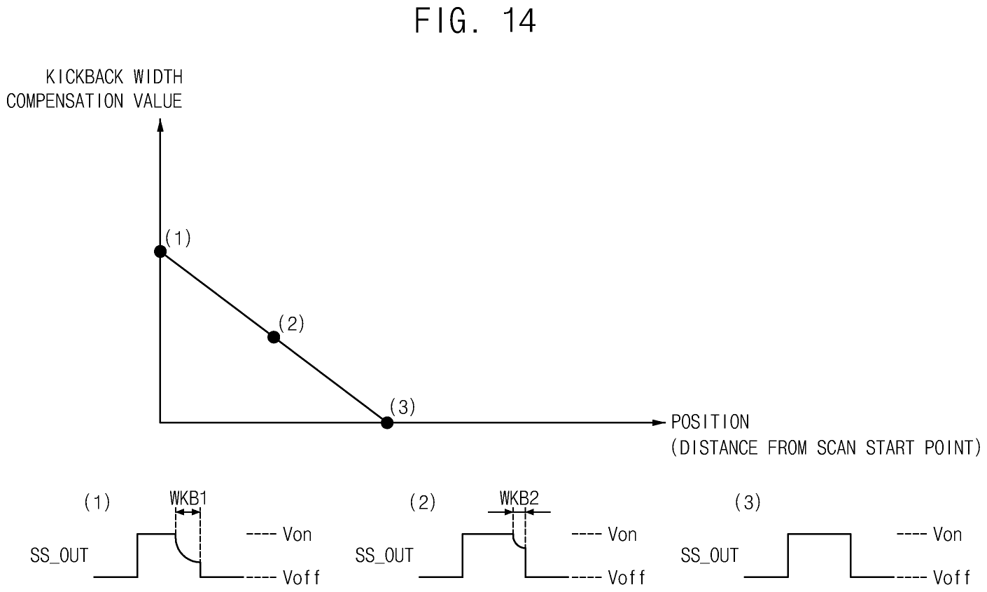

FIG. 14 is a graph illustrating the kickback width compensation value of the second gate signal SS of the third transistor T3 of FIG. 2 according to the distance from the scan start point of the second gate signal SS. FIG. 15 is a graph illustrating the kickback voltage compensation value of the second gate signal SS of the third transistor T3 of FIG. 2 according to the distance from the scan start point of the second gate signal SS.

As described with reference to FIGS. 6 and 7, the kickback width compensation value of the gate signal SC_OUT may be set to increase as the distance from the scan start point decreases, and the kickback voltage compensation value of the gate signal SC_OUT may be set to increase as the distance from the scan start point decreases.

Referring to FIG. 14, the kickback width compensation value of the second gate signal SS_OUT may increase as the distance from the scan start point is shorter. The kickback width compensation value of the second gate signal SS_OUT may be set to increase as the distance from the scan start point is shorter.

In FIG. 14, Case (1) may represent a case in which the distance from the scan start point is the shortest, and the kickback width compensation value WKB1 of the second gate signal SS_OUT in Case (1) may be the largest. Case (2) may represent a case in which a distance from the scan start point of Case (2) is longer than a distance from the scan start point of Case (1), and the kickback width compensation value WKB2 of the gate signal, e.g., SC_OUT, in Case (2) may be smaller than the kickback width compensation value WKB1 in Case (1). Case (3) may represent a case in which the distance from the scan start point is the longest, and the kickback width compensation value of the second gate signal SS in Case (3) may be the smallest.

Referring to FIG. 15, the kickback voltage compensation value of the second gate signal SS may increase as the distance from the scan start point is shorter. The kickback voltage compensation value of the second gate signal SS may be set to increase as the distance from the scan start point is shorter.

In FIG. 15, Case (1) may represent a case in which the distance from the scan start point is the shortest, and the kickback voltage compensation value VKB1 of the second gate signal SS_OUT in Case (1) may be the largest. Case (2) may represent a case in which a distance from a scan start point of Case (2) is longer than the distance from the scan start point of Case (1), and the kickback voltage compensation value VKB2 of the second gate signal SS_OUT in Case (2) may be smaller than the kickback voltage compensation value VKB1 in Case (1). Case (3) may represent a case in which the distance from the scan start point is the longest, and the kickback voltage compensation value of the second gate signal SS_OUT in Case (3) may be the smallest.

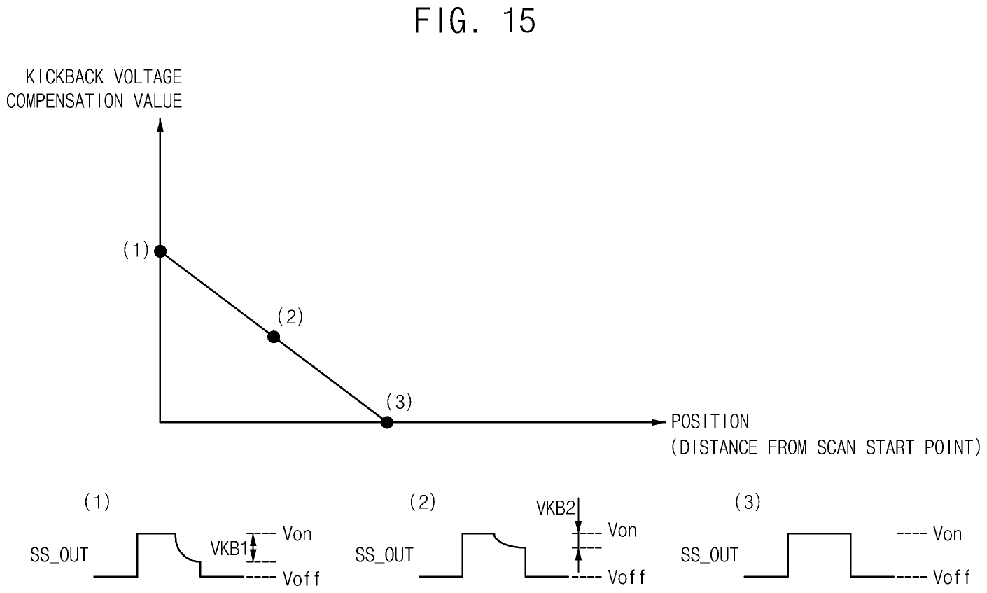

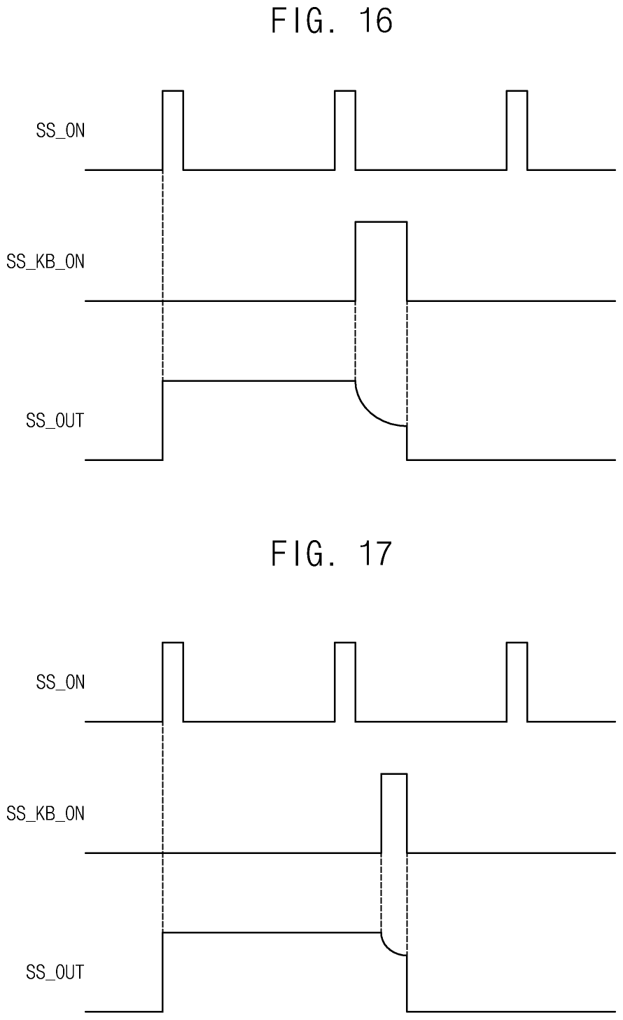

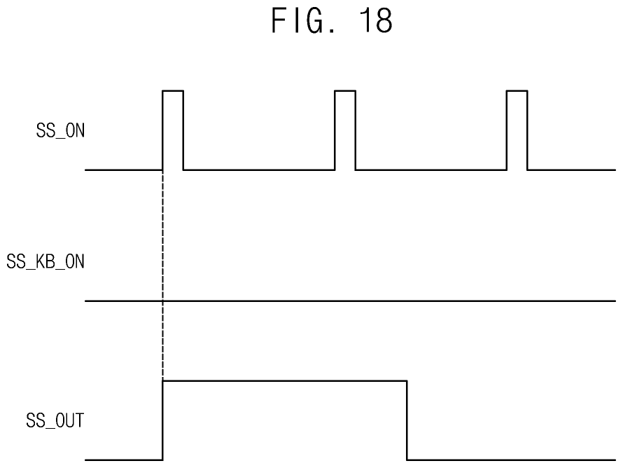

FIG. 16 is a timing diagram illustrating an embodiment of a waveform of the second gate signal SS_OUT of the third transistor T3 of FIG. 2 according to a second gate-on signal SS_ON and a second gate-kickback-on signal SS_KB_ON. FIG. 17 is a timing diagram illustrating an embodiment of the waveform of the second gate signal SS_OUT of the third transistor T3 of FIG. 2 according to the second gate-on signal S S_ON and the second gate-kickback-on signal SS_KB_ON. FIG. 18 is a timing diagram illustrating an embodiment of the waveform of the second gate signal SS_OUT of the third transistor T3 of FIG. 2 according to the second gate-on signal SS_ON and the second gate-kickback-on signal SS_KB_ON.

Referring FIGS. 16 to 18, the driving controller 200 may output the second gate-on signal SS_ON determining an on-time of the second gate signal SS_OUT sequentially applied to the pixel rows and the second gate-kickback-on signal SS_KB_ON determining an on-time of the kickback compensation of the second gate signal SS_OUT sequentially applied to pixel rows to the gate driver 300.

The gate driver 300 may generate the kickback-compensated first gate signal SS_OUT based on the second gate-on signal SS_ON and the second gate-kickback-on signal SS_KB_ON.

For example, the kickback width compensation value of the second gate signal SS may be determined by an active period of the second gate-kickback-on signal SS_KB_ON. The on-time of the second gate signal SS may be a time point at which an active period of the second gate-on signal SS_ON starts. An off-time of the second gate signal SS may be a time point at which an active period of the second gate-kickback-on signal SS_KB_ON ends.

The second gate-on signal SS_ON may have pulses. When the second gate-on signal SS_ON is periodically activated, the activated second gate signal SS_OUT may be sequentially applied to the pixel rows.

FIGS. 8 to 10 represent a case of generating the kickback-compensated first gate signal SC_OUT based on the first gate-on signal SC_ON and the first gate kickback-on signal SC_KB_ON.

FIGS. 16 to 18 represent a case of generating the kickback-compensated second gate signal SS_OUT based on the second gate-on signal SS_ON and the second gate-kickback-on signal SS_KB_ON in the same manner as in FIGS. 8 to 10.

In the present embodiment, the kickback compensation value of the gate signals SC, SS may be determined according to at least one of the grayscale value of the input image data IMG and the distance from the scan start point of the gate signals SC, SS, and the gate signals SC, SS may be generated based on the kickback compensation value.

The luminance reduction, which occurs when the waveform of the gate signals SC, SS rapidly decreases from the high level to the low level, may be determined by the grayscale value of the input image data IMG or the distance from the scan start point of the gate signal SC.

Consequently, the non-uniformity of the luminance and the discoloration of the display panel 100 due to the difference in the degree of the kickback according to the grayscale value of the input image data IMG and the distance from the scan start point of the gate signals SC, SS may be prevented and the display quality of the display panel 100 may be enhanced.

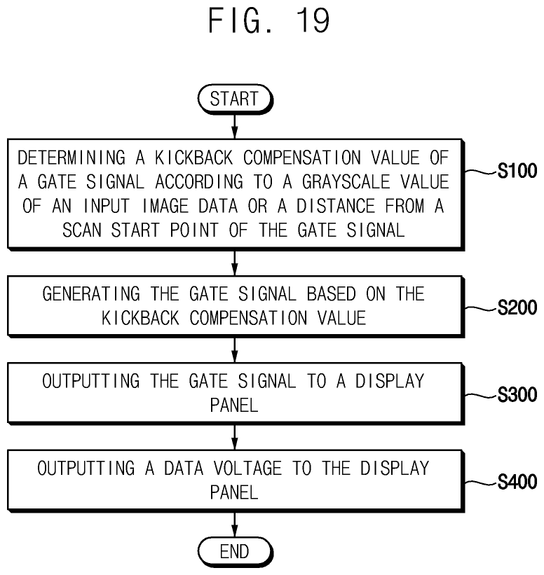

FIG. 19 is a flowchart illustrating a method of driving the display device according to an embodiment of the inventive concept.

Referring to FIG. 19, the method of driving the display device may include determining the kickback compensation value of the gate signal according to the grayscale value of the input image data IMG or the distance from the scan start point of the gate signal in an operation S100, i.e., according to at least one of the grayscale value of the input image data IMG and the distance from the scan start point of the gate signal. The gate signal is generated based on the kickback compensation value in an operation S200. The gate signal is output to the display panel 100 in an operation S300. The data voltage VDATA is output to the display panel 100 in an operation S400. For example, when the grayscale value of the input image data IMG is small, the kickback compensation value may increase. When the grayscale value of the input image data IMG is small, the kickback voltage compensation value may be large.

When the distance from the scan start point of the gate signal is short, the kickback compensation value may increase. When the distance from the scan start point of the gate signal is short, the kickback voltage compensation value may be large. When the distance from the scan start point of the gate signal is short, the kickback width compensation value may be large.

As such, the method of driving the display device may include generating the gate signal based on the kickback compensation value in the operation S200, outputting the gate signal to the display panel 100 in the operation S300 and outputting the data voltage VDATA to the display panel 100 in the operation S400.

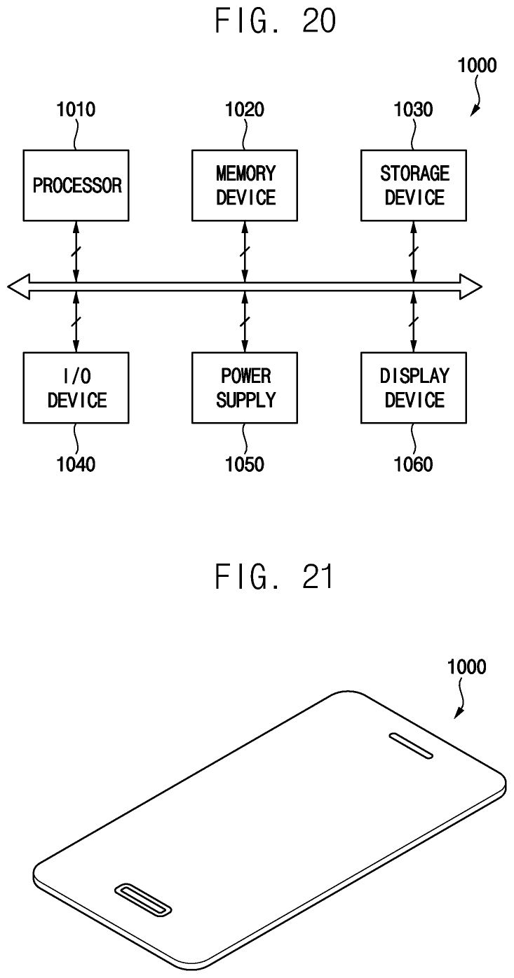

FIG. 20 is a block diagram illustrating an electronic device 1000 according to embodiment of the inventive concept. FIG. 21 is a diagram illustrating an example in which the electronic device 1000 of FIG. 20 is implemented as a smart phone.

Referring to FIGS. 20 and 21, the electronic device 1000 may include a processor 1010, a memory device 1020, a storage device 1030, an input/output (I/O) device 1040, a power supply 1050, and a display device 1060. The display device 1060 may be the display device 100 of FIG. 1. In addition, the electronic device 1000 may further include a plurality of ports for communicating with a video card, a sound card, a memory card, a universal serial bus (USB) device, other electronic device, and the like.

In an embodiment, as illustrated in FIG. 21, the electronic device 1000 may be implemented as a smart phone. However, in an embodiment, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions. The processor 1010 may be a micro processor, a central processing unit (CPU), an application processor (AP), and the like. The processor 1010 may be coupled to other components via an address bus, a control bus, a data bus, and the like. Further, the processor 1010 may be coupled to an extended bus such as a peripheral component interconnection (PCI) bus. The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like. The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060. The power supply 1050 may provide power for operations of the electronic device 1000.

The inventive concepts may be applied to any display device and any electronic device including the touch panel. For example, the inventive concepts may be applied to a mobile phone, a smart phone, a tablet computer, a digital television (TV), a 3D TV, a personal computer (PC), a home appliance, a laptop computer, a personal digital assistant (PDA), a portable multimedia player (PMP), a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, any means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel including pixels;
a driving controller configured to determine a kickback compensation value of a gate signal according to at least one of a grayscale value of an input image data and a distance from a scan start point of the gate signal;
a gate driver configured to generate the gate signal based on the kickback compensation value and to output the gate signal to the display panel; and
a data driver configured to output a data voltage to the display panel.

2. The display device of claim 1, wherein the driving controller is configured to determine the kickback compensation value of the gate signal according to both of the grayscale value of the input image data and the distance from the scan start point of the gate signal.

3. The display device of claim 1, wherein the kickback compensation value of the gate signal increases as the grayscale value of the input image data decreases.

4. The display device of claim 3, wherein a kickback voltage compensation value of the gate signal increases as the grayscale value of the input image data decreases.

5. The display device of claim 3, wherein a kickback width compensation value of the gate signal increases as the grayscale value of the input image data decreases.

6. The display device of claim 5, wherein the driving controller is configured to output a gate-on signal determining an on-time of the gate signal and a gate-kickback-on signal determining an on-time of a kickback compensation of the gate signal, and
wherein the gate driver is configured to generate the gate signal based on the gate-on signal and the a gate-kickback-on signal.

7. The display device of claim 6, wherein the kickback width compensation value is determined by an active period of the gate-kickback-on signal.

8. The display device of claim 3, wherein a kickback voltage compensation value of the gate signal increases and a kickback width compensation value of the gate signal increases, as the grayscale value of the input image data decreases.

9. The display device of claim 1, wherein the kickback compensation value of the gate signal increases as the distance from the scan start point of the gate signal decreases.

10. The display device of claim 9, wherein a kickback voltage compensation value of the gate signal increases as the distance from the scan start point of the gate signal decreases.

11. The display device of claim 9, wherein a kickback width compensation value of the gate signal increases as the distance from the scan start point of the gate signal decreases.

12. The display device of claim 9, wherein a kickback voltage compensation value of the gate signal increases and a kickback width compensation value of the gate signal increases, as the distance from the scan start point of the gate signal decreases.

13. The display device of claim 1, wherein a pixel circuit of the pixels of the display panel includes:
a first transistor including a gate terminal connected to a first node, a first terminal connected to a second node and a second terminal configured to receive a first power voltage;
a second transistor including a gate terminal configured to receive a first gate signal, a first terminal connected to a date line and a second terminal connected to the first node;
a third transistor including a gate terminal configured to receive a second gate signal, a first terminal connected to a sensing line and a second terminal connected to the second node;
a first storage capacitor including a first terminal connected to the first node and a second terminal connected to the second node;
a second storage capacitor including a first terminal connected to the second node and a second terminal connected to a third node; and
a light emitting element including a first terminal connected to the second node and a second terminal configured to receive a second power voltage lower than the first power voltage.

14. The display device of claim 13, wherein the driving controller is configured to determine a kickback compensation value of the first gate signal applied to the gate terminal of the second transistor according to at least one of the grayscale value of the input image data and a distance from a scan start point of the first gate signal.

15. The display device of claim 13, wherein the driving controller is configured to determine a kickback compensation value of the first gate signal applied to the gate terminal of the second transistor and a kickback compensation value of the second gate signal applied to the gate terminal of the third transistor according to at least one of the grayscale value of the input image data and a distance from a scan start point of the first gate signal and the second gate signal.

16. The display device of claim 1, wherein the driving controller includes a line memory storing a line data corresponding to one gate line of the display panel, and
wherein the driving controller is configured to determine the kickback compensation value of the gate signal based on the line data.

17. The display device of claim 16, wherein the driving controller is configured to determine the kickback compensation value of the gate signal based on at least one of a maximum grayscale value of the line data, a minimum grayscale value of the line data, and an average grayscale value of the line data.

18. A method of driving a display device, the method comprising:
determining a kickback compensation value of a gate signal according to at least one of a grayscale value of an input image data and a distance from a scan start point of the gate signal;
generating the gate signal based on the kickback compensation value;
outputting the gate signal to a display panel; and
outputting a data voltage to the display panel.

19. The method of claim 18, wherein the kickback compensation value of the gate signal increases as the grayscale value of the input image data decreases or as the distance from the scan start point of the gate signal decreases.

20. A display panel driver comprising:
a driving controller configured to determine a kickback compensation value of a gate signal according to at least one of a grayscale value of an input image data and a distance from a scan start point of the gate signal; and
a gate driver configured to generate the gate signal based on the kickback compensation value.
